(19) United States
(12) Patent Application Publication
(10) Pub. No.: US 2021/0096563 A1
(43) Pub. Date: Apr. 1, 2021

(54) Active-Stop Mode Associated with a Vehicle having Autonomous Function

(71) Applicant: Robert Bosch GmbH, Stuttgart (DE)

(72) Inventors: Tong Mu, Novi, MI (US); Hsien-cheng Wu, Novi, MI (US); Wenguang Zhou, Heilbron (DE)

(21) Appl. No.: 16/585,489

(22) Filed: Sep. 27, 2019

(51) Int. Cl. G05D 1/00; B60W 30/095; B60W 50/10

(52) U.S. Cl. CPC G05D 1/0061; B60W 30/0956; B60W 2050/0073; G05D 1/0088; B60W 50/10

(57) ABSTRACT

A vehicle having an autonomous function that can initiate an active-stop mode in the event that a driver-takeover mode is not successfully completed in response to detecting a condition warranting driver takeover from the autonomous function. In some embodiments, an emergency-stop mode may override the driver-takeover mode or the active-stop mode in response to detection of a condition warranting an emergency stop.

### TECHNICAL FIELD

This disclosure relates to an autonomous braking function of a vehicle.

### BACKGROUND

For vehicles having an autonomous function, situations may be encountered in which the programming of the vehicle is less preferable than human control of the vehicle. These situations may include unpredicted situations, such as unexpected environmental conditions or unexpected conditions of systems the vehicle relies upon for autonomous function.

However, takeover of control of the vehicle by a human may not be accomplished in a manner anticipated by the autonomous systems. A contingency operation of the autonomous functions for when human takeover is not accomplished as anticipated would be advantageous.

### SUMMARY

One aspect of this disclosure is directed to a vehicle handing an autonomous driving function, the vehicle comprising a processor, a sensor in data communication with the processor, a brake system in data communication with the processor, and a steering system in data communication with the processor. The sensor may be operable to generate sensor data that the processor may use to describe the environment in which the vehicle is operating. The brake system and steering system may be operable to generate signals that indicate user input of each system respectively, and may receive control signals from the processor to autonomously function. In the event that a condition is detected warranting a driver takeover, the vehicle may initiate a driver-takeover mode but then initiate an active-stop mode if a user does not provide input within a threshold time limit. The active-stop mode may be operable to designate a stopping point for the vehicle, navigate to the stopping point, and stop the vehicle at the stopping point.

Another aspect of this disclosure is directed to a method of autonomous braking in a vehicle having an autonomous function. The method may comprise the steps of initiating a driver-takeover mode in response to detection of a condition warranting driver takeover, indicating to a driver the initiation of the driver-takeover mode and starting a timer upon indication. If the timer reaches a threshold value without any input from the driver indicating takeover of controls, initiating an active-stop mode, wherein the active-stop mode comprises designating a stopping point for the vehicle, navigating to the stopping point, and stopping the vehicle at the stopping point.

A further aspect of this disclosure is directed to an autonomous-stopping system for a vehicle, the system comprising a processor, a sensor in data communication with the processor, a brake system in data communication with the processor, and a steering system in data communication with the processor. The sensor may be operable to generate sensor data that the processor may use to describe the environment in which the vehicle is operating. The brake system and steering system may be operable to generate signals that indicate user input of each system respectively, and may receive control signals from the processor to autonomously function. In the event that a condition is detected warranting a driver takeover, the vehicle may initiate a driver-takeover mode but then initiate an active-stop mode if a user does not provide input within a threshold time limit. The active-stop mode may be operable to designate a stopping point for the vehicle, navigate to the stopping point, and stop the vehicle at the stopping point.

The above aspects of this disclosure and other aspects will be explained in greater detail below with reference to the attached drawings.

### BRIEF DESCRIPTION OF THE DRAWINGS

FIG. 1 is a diagrammatic illustration of a vehicle having a system operable for an active-stop mode.

FIG. 2 is a diagrammatic illustration of a vehicle operating in an active-stop mode.

FIG. 3 is a diagrammatic illustration of a vehicle operating in an emergency-stop mode.

FIG. 4 is a flow hart illustrating an example of a method of operating an active-stop mode in a vehicle with an autonomous function.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

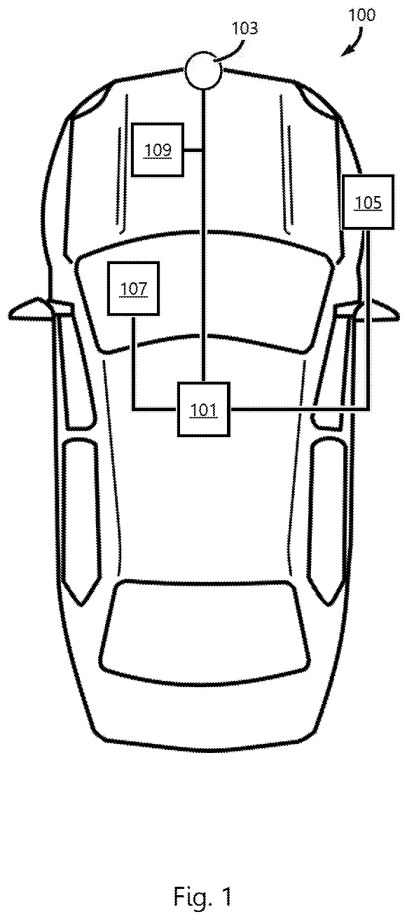

FIG. 1 shows a vehicle 100 having a system operable to perform an autonomous function according to one embodiment of the teachings disclosed herein. The vehicle may comprise a processor 101, a sensor 103, a brake system 105, a steering system 107, and a mover-operation system 109. Each of sensor 103, brake system 105, steering system 107, and mover-operation system 109 may be in data communication with processor 101. In the depicted embodiment, vehicle 100 comprises a personal automobile, but other embodiments may comprise a commercial automobile, a watercraft, an aircraft, a rail vehicle, or other vehicles having an autonomous function known to one of ordinary skill in the art without deviating from the teachings disclosed herein.

Sensor 103 may be operable to generate data describing one or more conditions of an environment in which vehicle 100 is operated. Sensor 103 may comprise a proximity sensor, ultrasonic sensor, radar sensor, lidar sensor, optical sensor, camera sensor, thermometer, hygrometer, pressure sensor, motion sensor, infrared sensor, ultraviolet sensor, global-positioning sensor, or any other sensor blown to one of ordinary skill in the art to be useful in generate data to describe a local environment for a vehicle without deviating from the teachings described herein. In the depicted embodiment, sensor 103 is disposed at least partly within the body of vehicle 100, but other embodiments may comprise other arrangements without deviating from the teachings disclosed herein. In the depicted embodiment, sensor 103 is configured as a single sensor arranged at the front of vehicle 100, but other embodiments may comprise other arrangements having a different position or number of sensors without deviating from the teachings disclosed herein. In some embodiments having multiple sensors 103, the sensors may comprise different types or configurations without deviating from the teachings disclosed herein.

Brake system 105 is in data communication with processor 101, and may be operable to generate a driver-brake signal indicating activation of the brakes of vehicle 100 by a driver of the vehicle. Brake system 105 may further be operable to receive a braking-control signal from processor 101, the braking-control signal operable to activate the brakes of vehicle 100. The braking-control signal may be operable to apply varying degrees of braking force to the vehicle 100, providing a variety of options to control the forward motion of the vehicle. In the depicted embodiment, a braking-control signal sent from processor 101 may be sufficient to slow forward motion of vehicle 100 to an eventual halt even at high speeds, such as speeds experienced on highways. Other embodiments may comprise other braking options using the braking-control signal without deviating from the teachings disclosed herein. In the depicted embodiment, brake system 105 is positioned near a wheel-well of vehicle 100, but other embodiments may comprise other arrangements without deviating from the teachings disclosed herein.

Steering system 107 is in data communication with processor 101, and may be operable to generate a driver-steering signal indicating activation of the steering of vehicle 100 by a driver of the vehicle. Steering system 107 may further be operable to receive a steering-control signal from processor 101, the steering-control signal operable to control the steering mechanisms of vehicle 100. The steering-control signal may be operable to navigate the vehicle 100 within a specified range of motion designated for operation of the vehicle. In the depicted embodiment, the steering-control signal may be sufficient to provide turning motion of vehicle 100 up to 90-degree turns, but other embodiments may comprise other specified maneuverability without deviating from the teachings disclosed herein. In some embodiments, the maneuverability of vehicle 100 in response to the steering-control signal may be limited with respect to the instantaneous speed of vehicle 100 for reasons of safety, legal compliance, or comfort of passengers. In the depicted embodiment, steering system 107 is positioned near the steering column of vehicle 100, but other embodiments may comprise other arrangements without deviating from the teachings disclosed herein.

Mover-operation system 109 is in data communication with processor 101, and may be operable to generate a driver-mover signal indicating activation of the propulsion controls of a prime mover of the vehicle by a driver. The prime mover of vehicle 100 may comprise an internal combustion engine, electric motor, hybrid motor, diesel engine, steam engine, jet, engine, propeller, or other prime mover of a vehicle known to one of ordinary skill in the art without deviating from the teachings disclosed herein. For the purposes of illustration, and not limitation, the depicted embodiment may comprise a prime mover in the form of a hybrid engine, which is operable to respond to input from an accelerator and gear-shift transmission. Mover-operation system 109 may further be operable to receive a mover-control signal from processor 101, the mover-control signal operable to control the accelerator and gear-shift transmission of the prime mover. The mover-control signal may be operable to control the forward motion and operation of the prime mover within a specified range of operating speeds designated for the vehicle. The mover-control signal may be operable to disengage the prime mover of vehicle 100. In the depicted embodiment, the mover-operation signal may be sufficient to provide forward- and backward-motion of vehicle 100 at low speeds (such as those suitable for parking or maneuvering on a driveway) and high speeds (such as those suitable for maintaining the flow of traffic on a highway). In some embodiments, the moving speed of vehicle 100 in response to the mover-control signal may be limited for reasons of safety, legal compliance, or comfort of passengers. In the depicted embodiment, mover-operation system 109 is positioned near the prime mover of vehicle 100, but other embodiments may comprise other arrangements without deviating from the teachings disclosed herein.

Processor 101 may further be operable to analyze data received from sensor 103, brake system 105, steering system 107, or mover-operation system 109 for the purpose of optimizing autonomous functions of vehicle 100. Vehicle 100 may operate in an autonomous mode utilizing one or more autonomous functions. If processor 101 detects an anomalous condition within the data during the autonomous mode, the operational mode of vehicle 100 may be changed or one or more autonomous functions may be adjusted or disabled. In some embodiments, the operational changes resulting from the detection of an anomalous data condition may be temporary until such time that the anomalous condition is no longer detected. In some embodiments, different types of anomalous conditions may be treated differently: some anomalous conditions resulting in temporary operational changes, and others maintained until vehicle 100 is provided servicing to correct the condition.

Anomalous conditions within the data may comprise error signals generated by one or more elements of vehicle 100. Error signals may be generated to indicate a fault in a sensor or controller of an element, such as a diagnostic trouble code (DTC). Error signals may be generated in response to unexpected data, or data that does not conform to specified behaviors expected by processor 101.

Anomalous conditions within the data may comprise environmental conditions in which one or more autonomous functions of vehicle 100 are not desirable. Environmental conditions may comprise weather or electro-magnetic conditions interfering with a sensor or control-system of vehicle 100, temperatures outside the specified operational range for a component of vehicle 100, or traffic conditions outside of the specified operational conditions for vehicle 100. Environmental conditions may comprise legal restrictions indicating limited usage of one or more autonomous functions of vehicle 100. By way of example, and not limitation, in municipalities where only some forms of autonomous driving are legally permitted, vehicle 100 may detect its location and selectively enable and disable autonomous functions in response.

Anomalous conditions within the data may comprise expected conditions in which or more or more autonomous functions of vehicle 100 are not desirable. For example, sensor 103 may be specified to require re-calibration after a designated distance of travel, and upon achieving such a distance the data may indicate that sensor 103 should be recalibrated to ensure optimized operation.

Vehicle 100 may comprise, indicators providing to one or more passengers detection of an anomalous condition. Indicators may comprise visual indicators, audible indicators, or haptic indicators. The indicators may additional comprise an indication of a current operational mode of vehicle 100, such as a fully-autonomous mode, a partially-autonomous mode(s), or a driver-takeover mode requiring driver control of one or more functions of the vehicle. A driver-takeover mode may be initiated in response to response detection of an anomalous condition warranting a driver takeover, hereinafter referred to as a “takeover condition.”

In response to detection of a takeover condition, vehicle 100 may initiate driver-takeover mode and a timer. In the event that the timer reaches a threshold value without processor 101 detecting a driver-brake signal, driver-steering signal, or driver-mover signal, an additional active-stop mode may be initiated. In the active-stop mode of vehicle 100, processor 101 may be operable to designate a stopping point within the environment, and then navigate to the stopping point using a brake-control signal, a steering-control signal, a mover-control signal, or some combination thereof. Upon navigating to the stopping point, processor 101 may stop the motion of the vehicle using a brake-control signal, a steering-control signal, a mover-control signal, or some combination thereof. In the depicted embodiment, processor 101 may be programmed to designate a stopping point that is optimized for proximity, safety of the stopping point, and ease of navigation to the stopping point. Some embodiments may utilize other or optimization factors in designating a stopping point without deviating from the teachings disclosed herein.

Vehicle 100 may additionally comprise an emergency-stop mode. An emergency-stop mode may be initiated in response to detection of a condition warranting an immediate stoppage of vehicle 100, such as a hazardous road condition or a predicted collision. In the depicted embodiment, an emergency-stop mode initiation may interrupt the operation of vehicle 100 in any other mode in response to detection of a condition warranting an emergency stop.

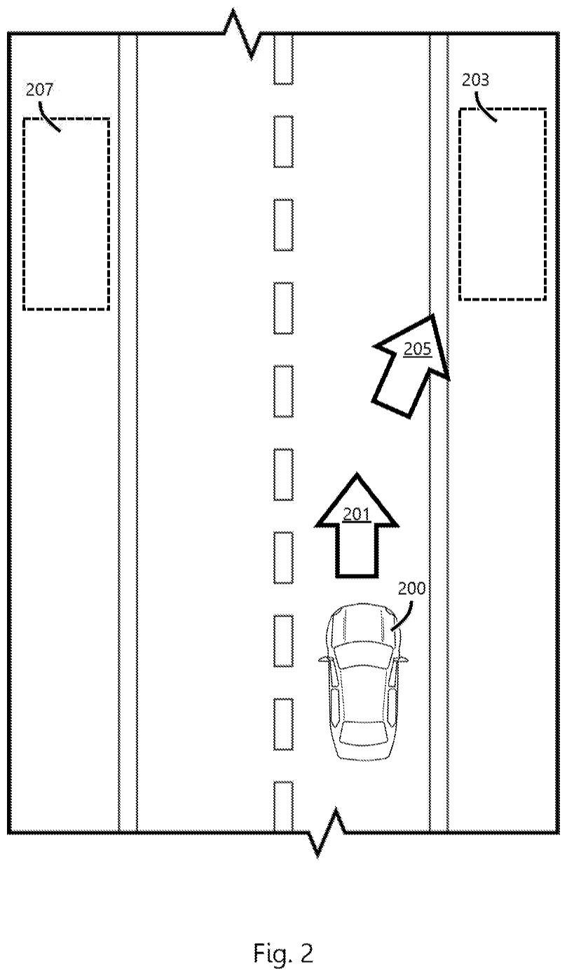

FIG. 2 is a diagrammatic illustration of operation of a vehicle 200 during initiation of an active-stop mode. In the depicted embodiment, vehicle 200 may comprise an automobile having one or more autonomous functions, such as vehicle 100 (see FIG. 1), but this embodiment is presented by way of illustration and not limitation. In FIG. 2, vehicle 200 is initially traveling in a direction 201 When a condition warranting driver-takeover mode is detected, such as vehicle 200 approaching an area in which autonomous functions are not legally permitted. Vehicle 200 may then initiate a timer concurrently with an indication of the driver-takeover mode. If the vehicle 200 does not detect driver input within a specified threshold time, vehicle 200 may initiate active-stop mode. In active-stop mode, vehicle 200 may utilize one or more sensors (such as sensor 103; see FIG. 1) to identify and designate a stopping point 203. Stopping point 203 may be selected based on optimization factors, such as proximity to vehicle 200, predicted safety of the vehicle to be stopped at this point, and ease of navigation to the point. Once stopping point 203 has been designated, vehicle 200 may change course to move in direction 205 toward stopping point 203, and halt motion after successfully navigating to stopping point 203. Upon halting motion, vehicle 200 may wait for driver input to successfully transition to a driver-takeover mode or disable vehicle 200. In some embodiments, a stoppage-timer may be initiated, measuring the amount of time passed without driver input. If a specified threshold time is reached by the stoppage-timer, vehicle 200 may disable its functions for purposes of safety.

In the depicted embodiment, stopping point 203 represents an optimized location for stoppage of vehicle 200 during the active-stop mode operation. By way of example, and not limitation, an unselected point 207 would not be preferred because of the optimization factors of the active-stop mode. In the depicted embodiment, =selected point 207 is more difficult to navigate to because vehicle 200 must make more dramatic steering operations and cross more lanes of active traffic. In the depicted embodiment, selected point 207 is also less safe for the purposes of stopping because it is nearer to faster-moving left-lane traffic, and may require a passenger of vehicle 200 to cross the road to leave the surrounding environment, either in vehicle 200 or on foot. Vehicle 200 may be programmed with such optimization factors to determine the optimized stopping point. Unselected stopping point 207 may be preferred in other scenarios comprising other conditions, such as an obstruction of stopping point 203.

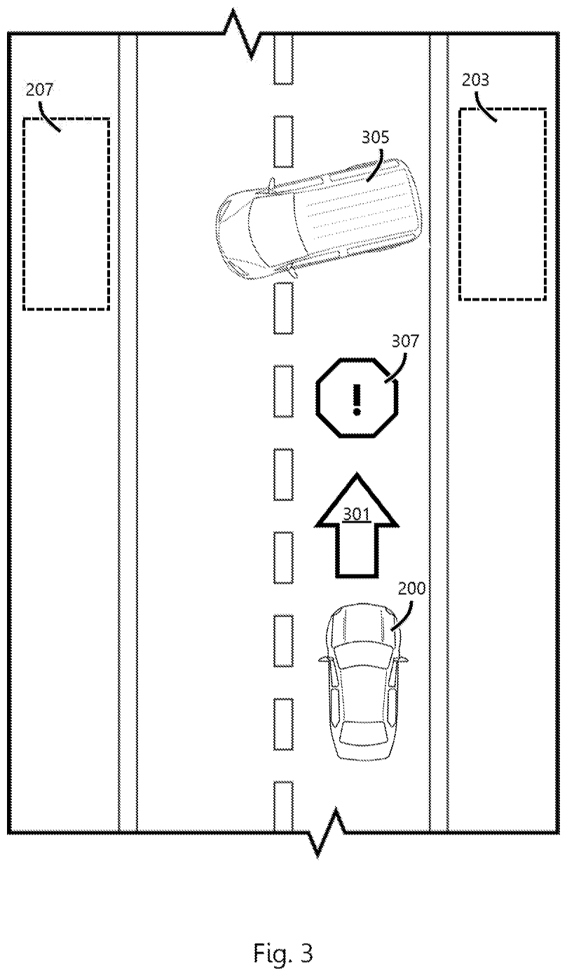

FIG. 3 is a diagrammatic illustration of vehicle 200 transitioning to an emergency-stop mode. An emergency-stop mode may be activated at any point during operation of vehicle 200 when a processor directed to an autonomous function of the vehicle (such as processor 101; see FIG. 1 predicts a collision or other scenario which can be prevented by a stoppage of the vehicle from further motion. In the depicted embodiment, vehicle 200 may comprise an automobile having one or more autonomous functions, such as vehicle 100 (see FIG. 1), but this embodiment is presented by way of illustration and not limitation. In FIG. 3, vehicle 200 is initially traveling in a direction 301 when a condition warranting driver-takeover mode is detected, such as vehicle 200 approaching an area in which autonomous functions are not legally permitted. Vehicle 200 may then initiate a timer concurrently with an indication of the driver-takeover mode. If the vehicle 200 does not detect driver input within a specified threshold time, vehicle 200 may initiate active-stop mode. In active-stop mode, vehicle 200 may utilize one or more sensors (such as sensor 103; see FIG. 1) to identify and designate a stopping point 203. Stopping point 203 may be selected based on optimization factors, such as proximity to vehicle 200, predicted safety of the vehicle to be stopped at this point, and ease of navigation to the point. However, in the depicted embodiment, vehicle 200 may be unable to approach stopping stop 203 because of obstruction caused by the environment, such as a stopped vehicle 305. In the depicted embodiment, vehicle 200 may detect that the unselected point 207 may also be obstructed, such as by stopped vehicle 305. The processor of vehicle 200 may predict that attempting to navigate to stopping point 203 or unselected point 207 may result in a collision with stopped vehicle 305, and also that continuing to travel in direction 301 may also result in a collision with stopped vehicle 305. In response, vehicle 200 may initiate an emergency-stop mode at point 307.

In emergency-stop mode, vehicle 200 may control the autonomous functions thereof to halt motion. In the depicted embodiment, the emergency-stop mode may engage the braking system or disengage the prime mover of vehicle 200. In some embodiments, vehicle 200 operating in, emergency-stop mode may be operable to maneuver the vehicle to avoid predicted collisions without deviating from the teachings disclosed herein. Some embodiments may comprise a different combination of these or other functions in an emergency-stop mode without deviating from the teachings disclosed herein.

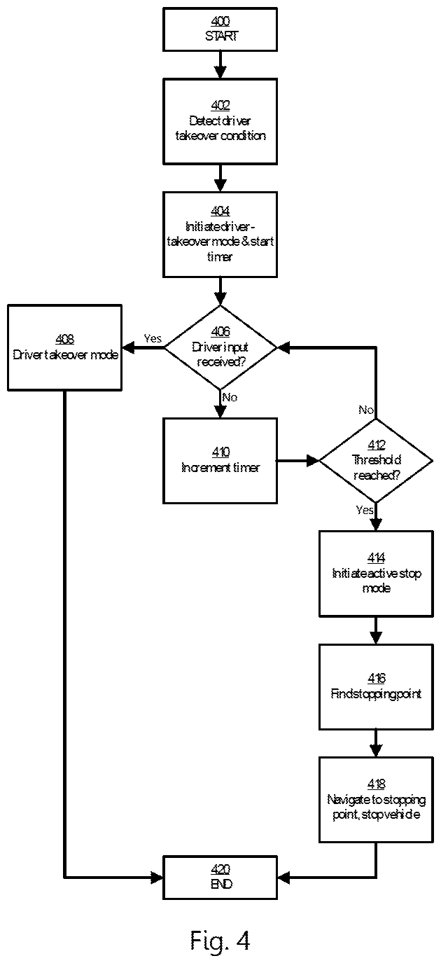

FIG. 4 is a flowchart showing a method of engaging an active-stop mode in a vehicle, such as vehicle 100 (see FIG. 1). The method begins at step 400, and the vehicle will operate in an autonomous mode or a partially-autonomous mode until such time that it detects a condition warranting driver takeover at step 402. After detection of a takeover condition, the method proceeds to step 404, where the vehicle initiates a driver-takeover mode and concurrently initiates a timer. The driver-takeover mode waits for a driver input, indicating that the driver has taken control of the functions of the vehicle at step 406. If driver input is received, driver-takeover mode is activated at step 408 and the method completes. If driver input is not received, the timer is incremented at step 410 and the current time is compared to a threshold time value at step 412. If the timer has not yet reached the threshold value, the method returns to step 406 to wait for driver input. If the timer does reach the threshold value without driver input, the method proceeds to step 414 to initiate an active-stop mode of the vehicle.

The active-stop mode may utilize one or more sensors of the vehicle to designate a suitable stopping point at step 416. A suitable stopping point may be designated based upon a number of factors, such as predicted safety of stopping at the point, proximity to the vehicle, safety in navigating to the point, and availability of the point for the vehicle to stop. Other embodiments may comprise additional or other factors without deviating from the teachings disclosed herein. The factors in designating a suitable stopping point may be weighted into a hierarchy to give more prominence to certain ones of the factors over others. By way of example, and not limitation, the predicted safety of the stopping point may be given more weight than the proximity of the stopping point to the vehicle. Other embodiments may utilize other weighting hierarchies without deviating from the teachings disclosed herein.

After designating a stopping point, the method proceeds to step 418, where the vehicle navigates to the stopping point and stops motion at the stopping point and await user takeover of the vehicle. Navigation to the stopping point may utilize one or more autonomous functions of the vehicle such as steering, braking, or mover-control. Stopping at the stopping point may utilize one or more autonomous functions of the vehicle such as steering, braking, or mover-control. The mover-control may comprise disengaging the prime mover of the vehicle at the stopping point. In some embodiments, a stoppage timer may initialize to track how long the vehicle remains stopped without user input. If the stoppage timer reaches a threshold value, the mover-control may disengage the prime mover of the vehicle, forcing a driver to re-engage the prime mover manually in order to pursue further motion.

After stopping the vehicle at the stopping point, the method completes at step 420. In the depicted embodiment, an emergency-stop mode may be initialized at any point in the method in response to detection of a condition warranting an emergency stop, such as prediction of a collision. In particular, an emergency-stop mode initialization may override the method after step 404, when the vehicle is configured to wait for driver input, or after step 414, when the vehicle initializes an active-stop mode.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A vehicle having an autonomous driving function, the vehicle comprising:
a processor disposed at least partly within the vehicle;
a sensor disposed at least partly within the vehicle, the sensor in data communication with the processor and operable to detect a condition of an environment in which the vehicle is operating;
a brake system in data communication with the processor and operable to generate a driver-brake signal indicating driver operation of the brake system and receive a braking-control signal from the processor, the brake system operable to apply a retardant force against the motion of the vehicle; and
a steering system in data communication with the processor and operable to generate a driver-steering signal indicating driver operation of the steering system and receive a steering-control signal from the processor, wherein
the processor is operable to receive data from the sensor and detect a takeover condition warranting driver takeover within the data, the processor further operable to respond to a detected takeover condition by initiating a timer and initiating a active-stop mode when the timer reaches a threshold value before the processor receives a driver-brake signal or a driver-steering signal, the active-stop mode comprising designating a stopping point for the vehicle, navigating to the stopping point, and stopping the vehicle at the stopping point.

2. The vehicle of claim 1, wherein the processor is further operable to detect a condition warranting an emergency stop within the data and initiate an emergency-brake mode in response to detection of a condition warranting an emergency stop, the emergency-brake mode comprising braking until the vehicle comes to a stop.

3. The vehicle of claim 2, wherein the condition warranting an emergency stop comprises a predicted collision.

4. The vehicle of claim 2, wherein the emergency-brake mode may override other operational modes of the processor.

5. The vehicle of claim 1, wherein the takeover condition comprises a sensor fault condition.

6. The vehicle of claim 1, further comprising a mover-operation system operable to receive a mover-control signal from the processor.

7. The vehicle of claim 6, wherein the processor is further operable to detect a condition warranting an emergency stop within the data and initiate an emergency-brake mode in response to detection of a condition warranting an emergency stop, the emergency-brake mode comprising disabling the prime mover.

8. A method of autonomous braking of a vehicle having an autonomous function, the method having the steps of:
initiating a driver-takeover mode in response to detection of a condition warranting driver takeover;
indicating to a driver the initiation of a driver-takeover mode and starting a timer upon the indication; and
initiating an active-stop mode in response to the timer achieving a threshold value without driver input, wherein
the active-stop mode operation comprises designating a stopping point for the vehicle, navigating the vehicle to the stopping point, and stopping the vehicle at the stopping point.

9. The method of claim 8, wherein the condition warranting driver takeover comprises detection of a sensor fault condition.

10. The method of claim 8, wherein the condition warranting driver takeover comprises detection of an anomalous sensor condition.

11. The method of claim 8, at any point after the step of initiating a driver-takeover mode, further having a step of initiating an emergency-brake mode in response to detection of a condition warranting an emergency stop, the emergency-brake mode comprising circumventing the method and braking until the condition warranting an emergency stop subsides.

12. The method of claim 11, wherein the emergency-brake mode further comprises disabling a prime mover of the vehicle.

13. The method of claim 11, wherein the condition warranting an emergency stop comprises a predicted collision.

14. An autonomous-stopping system for a vehicle, the system comprising:
a processor;
a sensor in data communication with the processor, the sensor operable to detect a condition of an environment. in which the vehicle is operating;
a brake system in data communication with the processor and operable to generate a driver-brake signal indicating driver operation of the brake system and receive a braking-control signal from the processor and
a steering system in data communication with the processor and operable to generate a driver-steering signal indicating driver operation of the steering system and receive a steering-control signal from the processor, wherein
the processor is operable to receive data from the sensor and detect a takeover condition warranting driver takeover within the data, the processor further operable to respond to a detected takeover condition by initiating a timer and initiating an active-stop mode when the timer reaches a threshold value before the processor receives a driver-brake signal or a driver-steering signal, the active-stop mode comprising designating a stopping point for the vehicle, navigating to the stopping point, and stopping the vehicle at the stopping point.

15. The autonomous-stopping system of claim 14, wherein the processor is further operable to detect a condition warranting an emergency stop within the data and initiate an emergency-brake mode in response to detection of a condition warranting an emergency stop, the emergency-brake mode comprising braking until the vehicle comes to a stop.

16. The autonomous-stopping ,system of claim 15, wherein the condition warranting an emergency stop comprises a predicted collision.

17. The autonomous-stopping system of claim 15, Wherein the emergency-brake mode may override other operational modes of the processor.

18. The autonomous-stopping system of claim 14, wherein the takeover condition comprises a sensor fault condition.

19. The autonomous-stopping system of claim 14, further comprising a mover-operation system operable to receive a mover-control signal from the processor.

70. The autonomous-stopping system of claim 19, wherein the processor is further operable to detect a condition warranting an emergency stop within the data and initiate an emergency-brake mode in response to detection of a condition warranting an emergency stop, the emergency-brake mode comprising disabling the prime mover.
